(19) United States
(12) Patent Application Publication
(10) Pub. No.: US 2014/0224703 A1
(43) Pub. Date: Aug. 14, 2014

(54) REMOVABLE TRAY ACCESSORY FOR A-FRAME LADDER

(71) Applicant: Joseph J. Valenti, Sayville, NY (US)

(72) Inventor: Joseph J. Valenti, Sayville, NY (US)

(21) Appl. No.: 13/764,993

(22) Filed: Feb. 12, 2013

(51) Int. Cl. E06C 7/14

(52) U.S. Cl. CPC E06C 7/14
USPC 206/557

(57) ABSTRACT

A tray that removably receives an open A-frame ladder. The tray is rigid and non-pivotable, is free of the pail rest of the open A-frame ladder, is free of the head step of the open A-frame ladder, and does not require holes in the side rails of the open A-frame ladder. The tray includes an open portion and a closed portion. The open portion extends rigidly from the closed portion, removably receives the open A-frame ladder and rests between the pail rest and the head step so as to allow the open portion and the closed portion to be free of the pail rest and the head step, non-pivotally receives the open A-frame ladder, and does not require holes in the side rails to attach to.

### 1. BACKGROUND OF THE INVENTION

A. Field of the Invention

The embodiments of the present invention relate to a ladder tray, and more particularly, the embodiments of the present invention relate to a tray for removably receiving an open A-frame ladder having a pail rest, a head step, side rails and a pair of spreaders, for being rigid and non-pivotable, for being free of the pail rest of the open A-frame ladder, for being free of the head step of the open A-frame ladder, and for not requiring holes in the side rails of the open A-frame ladder.

B. Description of the Prior Art

Numerous innovations for ladder trays have been provided in the prior art, which will be described below in chronological order to show advancement in the art, and which are incorporated in their entirety herein by reference thereto. Even though these innovations may be suitable for the specific individual purposes to which they address, nevertheless, they differ from the present invention in that they do not teach a tray for removably receiving an open A-frame ladder having a pail rest, a head step, and side rails, for being rigid and non-pivotable, for being free of the pail rest of the open A-frame ladder, for being free of the head step of the open A-frame ladder, and for not requiring holes in the side rails of the open A-frame ladder.

### (1) U.S. Pat. No. 4,121,692 to Morawski

U.S. Pat. No. 4,121,692—issued to Morawski on Oct. 24, 1978 in class 182 and subclass 129—teaches a ladder support for the upper end of a ladder, which incorporates a supporting frame member having three sides and two free ends. The two free ends are attachable to a portion of the ladder. A tray is within the frame member and has through bolts at the free ends of the frame member for passing completely through a rung of the ladder whereby the two free ends of the supporting frame are securely bolted to the ladder while permitting a floating action. Supporting legs extend from the frame at an angle to connect with another portion of the ladder. The support provides by use of the through bolt fastening a degree of flexibility in the attachment of the frame and tray to the ladder, which permits a desirable floating action so that the frame may conform to, for example, an irregular or angled surface while providing secure support for the top of the ladder.

### (2) U.S. Pat. No. 5,370,263 to Brown

U.S. Pat. No. 5,370,263—issued to Brown on Dec. 6, 1994 in U.S. class 220 and subclass 751—teaches a ladder caddy that includes a rigid tray and a ladder-engaging handle, which together define a generally rectangular mounting opening positioned laterally adjacent a mounting side of the tray. The mounting opening is of a size and shape for receiving therein an apex portion and portions of leg pairs of an A-frame ladder when the legs are in a separated and deployed configuration, but sufficiently small that the ladder-engaging handle and the rigid tray contact the separated leg pairs of the ladder near the apex portion whereby the ladder caddy remains mounted on the A-frame ladder. The ladder-engaging handle concludes two follower arms that are slidably engaged in track slots of the rigid tray. The ladder-engaging handle also includes an outer member or yoke bar that is rotatably attached to the follower arms and which can be rotated to change the size of the mounting opening. A separate top handle is rotatable between a vertical and deployed position and a horizontal and stored position.

### (3) U.S. Pat. No. 6,131,699 to Leak, Jr

U.S. Pat. No. 6,131,699—issued to Leak, Jr. on Oct. 17, 2000 in U.S. class 182 and subclass 129—teaches a ladder tray attachment for mounting to a head step of a stepladder for resting objects thereon. The ladder tray attachment includes a tray and a mounting frame for mounting the tray to a head step of a stepladder. The mounting frame includes a spaced-apart pair of generally inverted L-shaped mounting members, each has elongate top and bottom portions. The bottom portions of the mounting members are coupled to the tray so that the top portions of the mounting members outwardly extend from the tray. The mounting members each also have an elongate hooking portion downwardly depending from the top portion of the respective mounting member. The hooking portions of the mounting members each have spaced apart upper and lower hooks outwardly extending therefrom in a direction towards the bottom portions of the respective mounting member.

### (4) United States Patent Application Publication Number 2007/0051560 to Rittmann

United States Patent Application Publication Number 2007/0051560—published to Rittmann on Mar. 8, 2007 in U.S. class 182 and subclass 129—teaches a box with a top inside-surface prop-stop to hold a ladder's top portion a distance away from any vertical surface on which that ladder leans. The box is of a width to confine the outside sides of a prior art ladder's rails, of a top-wall depth to rest atop of a portion of same ladder, of a depth to substantially prop same ladder away from a vertical wall, of a length so that when positioned as described, the box's bottom-wall's front edge braces against the rear side of rails of same ladder.

### (5) United States Patent Application Publication Number 2008/0035426 to Leuthner

United States Patent Application Publication Number 2008/0035426—published to Leuthner on Feb. 14, 2008 in U.S. class 182 and subclass 129—teaches a ladder tray having a tubular frame, a tray member, and an adjustment bracket. The frame has an upper horizontal arm, a lower horizontal arm portion, a bridge portion connecting the upper and lower horizontal arms, and a support arm extending away from the bridge portion. A central portion of the tray is pivotally mounted to the upper horizontal arm portion. An adjustment bracket provides support and allows the tray to be secured to the ladder at different angled positions. The horizontal arms are received by adjacent hollow ladder rungs and a safety strap secures the tray to a side rail of the ladder.

### (6) United States Patent Application Publication Number 2009/0200189 to Fields

United States Patent Application Publication Number 2009/0200189—published to Fields on Aug. 13, 2009 in U.S. class 206 and subclass 372—teaches a ladder toolbox used to help people who need to carry miscellaneous materials and tools up an A frame ladder and remain safe and hands-free. It includes four sides slanting upwards to a flat top with handle. It is shaped in a flat topped pyramid style to shape to the form of an A frame ladder. The toolbox has compartments on all four sides that can be removable or permanent. The top is flat with a handle and is used as a resting tray for miscellaneous objects as big as a quart can or small as a tack. It safely secures over the top of the A frame ladder and all sides come down to the top most ladder step.

### (7) United States Patent Application Publication Number 2011/0203873 to Perry

United States Patent Application Publication Number 2011/0203873—published to Perry on Aug. 25, 2011 in U.S. class 182 and subclass 129—teaches a tray for supporting tools, paint cans, painting supplies, and the like, which is pivotally held in a selected position by an elongated frame removably attached to a ladder rail with at least a pair of hooks fitting over at least two rungs of the ladder enabling quick installation and removal from a straight ladder or extension ladder. The ladder tray includes a folding shelf, a shelf support, a rail embracing frame, and a hinge connecting the shelf and support to the frame. The ladder tray frame is attached to the ladder by hooks engaging the rungs, whereby the elongated frame includes apparatus for holding extending from its sides forming an elongated slot or groove cooperatively engaging a selected side rail of the ladder providing lateral support therefor. The ladder tray components are composed of plastic, structural foam material, aluminum, fiberglass, graphite material, wood, laminated or corrugated paper, or combinations thereof, or any other appropriately strong and light material. When mounted the ladder tray extends out from one side of the ladder and does not prevent a user from climbing up or down the ladder. It is foldable down alongside the rail of the ladder to a space saving transport or storage position or is folded and removed form the ladder to store. Due to the ladder tray's light weight and foldability, the ladder is easily moved, carried, or even stored with the ladder tray in place. A variety of apertures in various sizes and shapes are adapted for holding tools and a plurality of depressions or raised areas forming grooves or ridges in the surface of the shelf provide safe movement resisting areas for temporary placement of cans, bottles, jugs, tools, and the like on shelf areas.

It is apparent that numerous innovations for ladder trays have been provided in the prior art, which are adapted to be used. Furthermore, even though these innovations may be suitable for the specific individual purposes to which they address, nevertheless, they would not be suitable for the purposes of the embodiments of the present invention as heretofore described, namely, a tray for removably receiving an open A-frame ladder having a pail rest, a head step, and side rails, for being rigid and non-pivotable, for being free of the pail rest of the open A-frame ladder, for being free of the head step of the open A-frame ladder, and for not requiring holes in the side rails of the open A-frame ladder.

### 2. SUMMARY OF THE INVENTION

Thus, an object of the embodiments of the present invention is to provide a tray for removably receiving an open A-frame ladder having a pail rest, a head step, and side rails, for being rigid and non-pivotable, for being free of the pail rest of the open A-frame ladder, for being free of the head step of the open A-frame ladder, and for not requiring holes in the side rails of the open A-frame ladder, which avoids the disadvantages of the prior art.

Briefly stated, another object of the embodiments of the present invention is to provide a tray that removably receives an open A-frame ladder having a pail rest, a head step, side rails, and a pair of spreaders. The tray is rigid and non-pivotable, is free of the pail rest of the open A-frame ladder, is free of the head step of the open A-frame ladder, and does not require holes in the side rails of the open A-frame ladder. The tray includes an open portion and a closed portion. The open portion extends rigidly from the closed portion, removably receives the open A-frame ladder and rests between the pail rest of the open A-frame ladder and the head step of the open A-frame ladder when the tray is in use so as to allow the open portion and the closed portion to be free of the pail rest of the open A-frame ladder and the head step of the open A-frame ladder when the tray is in use, non-pivotally receives the open A-frame ladder when the tray is in use, and does not require holes in the side rails of the open A-frame ladder to attach to when the tray is in use.

The novel features considered characteristic of the embodiments of the present invention are set forth in the appended claims. The embodiments of the present invention themselves, however, both as to their construction and to their method of operation together with additional objects and advantages thereof will be best understood from the following description of the specific embodiments when read and understood in connection with the accompanying figures of the drawing.

### 3. BRIEF DESCRIPTION OF THE FIGURES OF THE DRAWING

The figures of the drawing are briefly described as follows:

FIG. 1 is a diagrammatic perspective view of the tray of the embodiments of the present invention removably receiving an open A-frame ladder having a pail rest, a head step, and side rails, being rigid and non-pivotable, being free of the pail rest of the open A-frame ladder, being free of the head step of the open A-frame ladder, and not requiring holes in the side rails of the open A-frame ladder;

FIG. 2 is an enlarged and partially phantomed diagrammatic perspective view of the area generally enclosed by the dotted curve identified by ARROW 2 in FIG. 1 of the tray of the embodiments of the present invention removably receiving an open A-frame ladder;

FIG. 3 is a reduced diagrammatic side elevational view taken generally in the directional of ARROW 3 in FIG. 2 of the tray of the embodiments of the present invention removably receiving an open A-frame ladder,

FIG. 4 is an enlarged diagrammatic side elevational view in partial section of the area generally enclosed by the dotted curve identified by ARROW 4 in FIG. 3 of the tray of the embodiments of the present invention removably receiving an open A-frame ladder, with the section thereof also illustrated taken in the direction ARROWS 4 along LINE 4-4; in FIG. 2;

FIG. 5 is an enlarged diagrammatic top plan view taken generally in the direction of ARROW 5 in FIG. 3 of just the tray of the embodiments of the present invention; and

FIG. 6 is a diagrammatic cross sectional view taken along LINE 6-6 in FIG. 5.

### 4. LIST OF REFERENCE NUMERALS UTILIZED IN THE FIGURES OF THE DRAWING

A. Introductory.
10 tray of embodiments of present invention for removably receiving open A-frame ladder 12 having pail rest 14, head step 16, and side rails 18, for being rigid and non-pivotable, for being free of pail rest 14 of open A-frame ladder 12, for being free of head step 16 of open A-frame ladder 12, and for not requiring holes in side rails 18 of open A-frame ladder 12 to attach to
12 open A-frame ladder
14 pail rest of open A-frame ladder 12
16 head step of open A-framed ladder 12
18 side rails of open A-framed ladder 12
19 pair of spreaders of open A-frame ladder 12

B. Overall Configuration of Tray 10.
20 open portion for removably receiving open A-frame ladder 12 and resting between pail rest 14 of open A-frame ladder 12 and head step 16 of open A-frame ladder 12 when tray 10 is in use so as to allow open portion 20 and closed portion 22 to be free of pail rest 14 of open A-frame ladder 12 and head step 16 of open A-frame ladder 12 when tray 10 is in use, for non-pivotally receiving open A-frame ladder 12 when tray 10 is in use, and for not requiring holes in side rails 18 of open A-frame ladder 12 to attach to when tray 10 is in use
22 closed portion for being free of pail rest 14 of open A-frame ladder 12 when tray 10 is in use, and for being free of head step 16 of open A-frame ladder 12 when tray 10 is in use

C. Specific Configuration of Open Portion 20.
24 open center of open portion 20 for removably and non-pivotally receiving open A-frame ladder 12 when tray 10 is in use
26 front wall defining open center 24 of open portion 20
28 rear wall defining open center 24 of open portion 20
30 pair of side walls defining open center 24 of open portion 20
32 lower edge of each side wall of pair of side walls 30 of open portion 20
34 upper edge of each side wall of pair of side walls 30 of open portion 20

D. Specific Configuration of Closed Portion 22.
36 front wall of closed portion 22
38 pair of side walls of closed
42 partition of front wall 26 of open portion 20
44 fence of closed portion 22 for preventing item 46 resting on floor 40 of closed portion 22 from inadvertently falling off closed portion 22
46 item
48 lower edge of each side wall of pair of side walls 38 of closed portion 22
50 upper edge of each side wall of pair of side walls 38 of closed portion 22

### 5. DETAILED DESCRIPTION OF THE PREFERRED EMBODIMENTS.

A. Introductory.

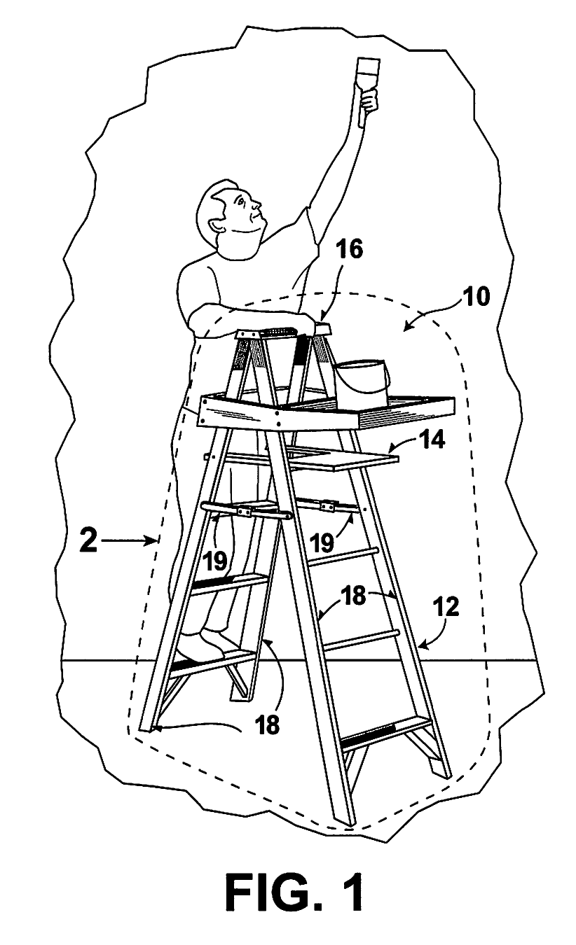

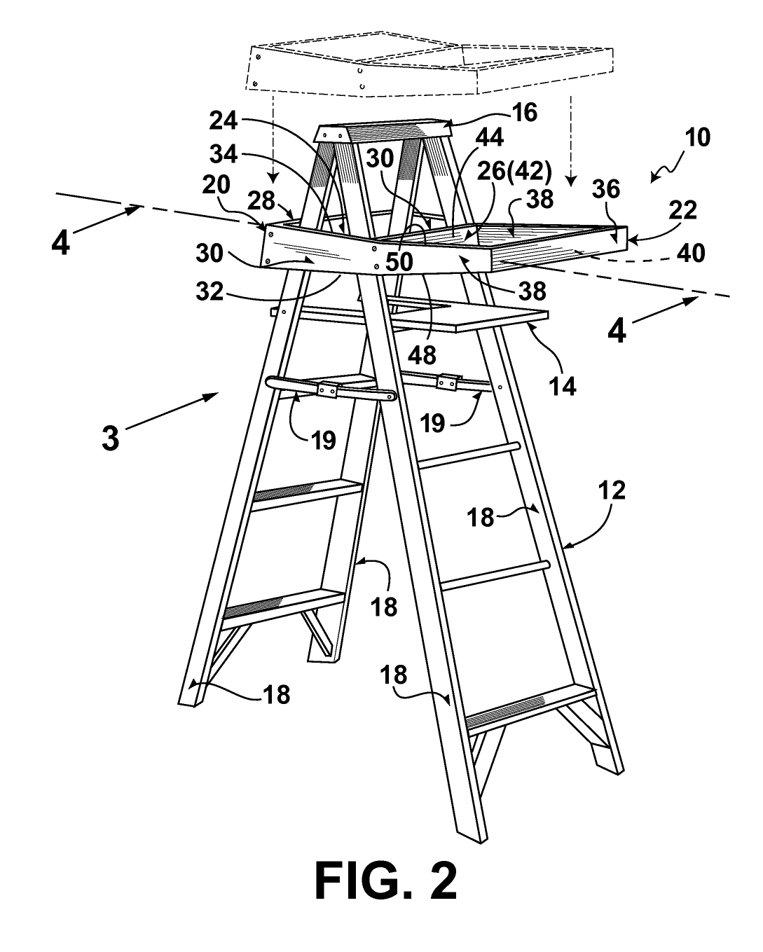

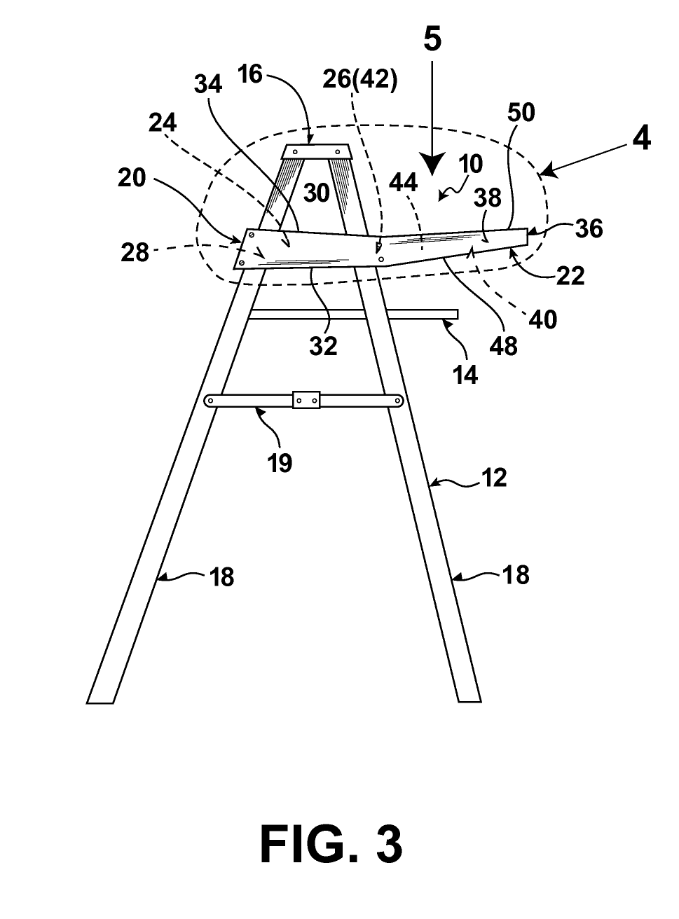

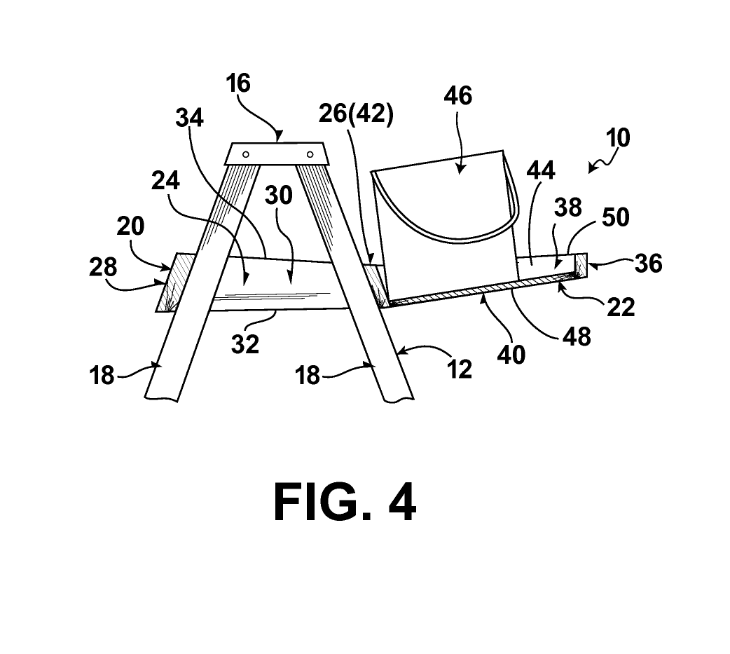

Referring now to the figures, in which like numerals indicate like parts, and particularly to FIGS. 1-4, which are, respectively, a diagrammatic perspective view of the tray of the embodiments of the present invention removably receiving an open A-frame ladder having a pail rest, a head step, and side rails, being rigid and non-pivotable, being free of the pail rest of the open A-frame ladder, being free of the head step of the open A-frame ladder, and not requiring holes in the side rails of the open A-frame ladder, an enlarged and partially phantomed diagrammatic perspective view of the area generally enclosed by the dotted curve identified by ARROW 2 in FIG. 1 of the tray of the embodiments of the present invention removably receiving an open A-frame ladder, a reduced diagrammatic side elevational view taken generally in the directional of ARROW 3 in FIG. 2 of the tray of the embodiments of the present invention removably receiving an open A-frame ladder, and an enlarged diagrammatic side elevational view in [partial section of the area generally enclosed by the dotted curve identified by ARROW 4 in FIG. 3 of the tray of the embodiments of the present invention removably receiving an open A-frame ladder, the tray of the embodiments of the present invention is shown generally at 10 for removably receiving an open A-frame ladder 12 having a pail rest 14, a head step 16, side rails 18, and a pair of spreaders 19, for being rigid and non-pivotable, for being free of the pail rest 14 of the open A-frame ladder 12, for being free of the head step 16 of the open A-frame ladder 12, and for not requiring holes in the side rails 18 of the open A-frame ladder 12 to attach to.

B. Overall Configuration of the Tray 10.

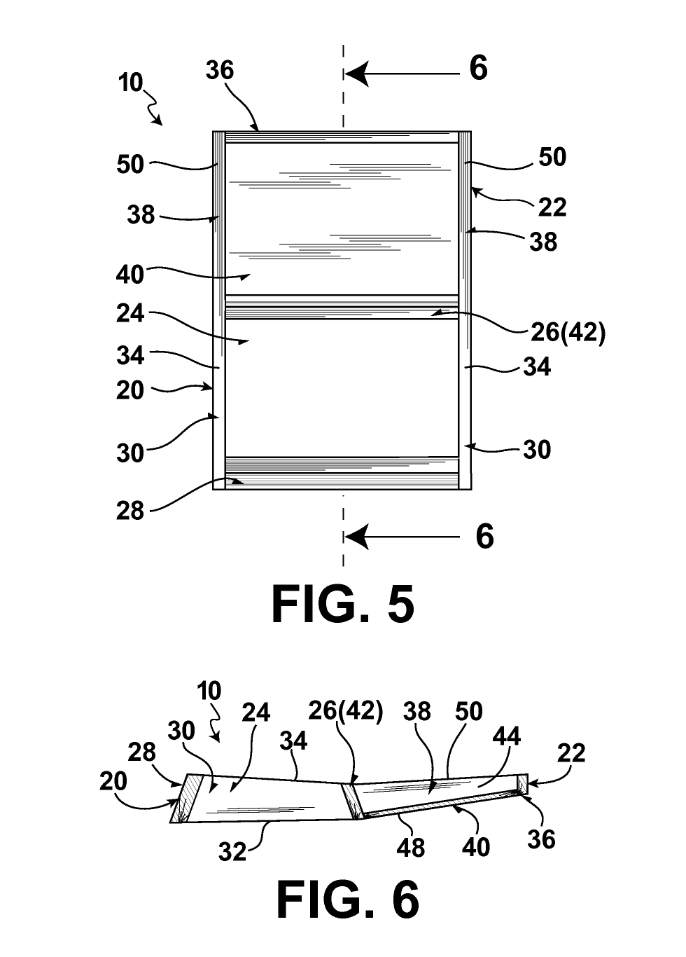

The configuration of the tray 10 can best be seen in FIGS. 2-6, which are, respectively, again, an enlarged and partially phantomed diagrammatic perspective view of the area generally enclosed by the dotted curve identified by ARROW 2 in FIG. 1 of the tray of the embodiments of the present invention removably receiving an open A-frame ladder, again, a reduced diagrammatic side elevational view taken generally in the directional of ARROW 3 in FIG. 2 of the tray of the embodiments of the present invention removably receiving an open A-frame ladder, again, an enlarged diagrammatic side elevational view in [partial section of the area generally enclosed by the dotted curve identified by ARROW 4 in FIG. 3 of the tray of the embodiments of the present invention removably receiving an open A-frame ladder, an enlarged diagrammatic top plan view taken generally in the direction of ARROW 5 in FIG. 3 of just the tray of the embodiments of the present invention, and a diagrammatic cross sectional view taken along LINE 6-6 in FIG. 5, and as such, will be discussed with reference thereto.

The tray 10 comprises an open portion 20 and a closed portion 22. The open portion 20 extends rigidly from the closed portion 22. The open portion 20 is for removably receiving the open A-frame ladder 12 and rests between the pail rest 14 of the open A-frame ladder 12 and the head step 16 of the open A-frame ladder 12 when the tray 10 is in use so as to allow the open portion 20 and the closed portion 22 to be free of the pail rest 14 of the open A-frame ladder 12 and the head step 16 of the open A-frame ladder 12 when the tray 10 is in use. The open portion 20 is for non-pivotally receiving the open A-frame ladder 12 when the tray 10 is in use. The open portion 20 is for not requiring holes in the side rails 18 of the open A-frame ladder 12 to attach to when the tray 10 is in use.

C. Specific Configuration of the Open Portion 20.

The open portion 20 is generally rectangular-shaped in plan view.

The open portion 20 has an open center 24. The open center 24 of the open portion 20 is for removably and non-pivotally receiving the open A-frame ladder 12 when the tray 10 is in use.

The open center 24 of the open portion 20 is defined by a front wall 26, a rear wall 28, and a pair of side walls 30.

The front wall 26 of the open portion 20, the rear wall 28 of the open portion 20, and the pair of side walls 30 of the open portion 20 are for being free of the pail rest 14 of the open A-frame ladder 12 and the head step 16 of the open A-frame ladder 12 when the tray 10 is in use.

The front wall 26 of the open portion 20 slants rearwardly for matching slant of, so as to rest snugly against, a front pair of side rails 18 of the open A-frame ladder 12.

The rear wall 28 of the open portion 20 slants forwardly for matching slant of, so as to rest snugly against, a rear pair of side rails 18 of the open A-frame ladder 12.

The pair of side walls 30 of the open portion 20 are identical to each other, are vertically oriented for matching vertical of, so as to rest snugly against, each side pair of side rails 18 of the open A-frame ladder 12, and are for acting like an additional pair of spreaders for the open A-frame ladder 12 in addition to the pair of spreaders 19 of the open a-frame ladder 12.

Each side wall 30 of the open portion 20 has a lower edge 32 and an upper edge 34.

The lower edge 32 of each side wall 30 of the open portion 20 is straight and extends forwardly horizontally from the rear wall 28 of the open portion 20 to the front wall 26 of the open portion 20.

The upper edge 34 of each side wall 30 of the open portion 20 is straight and extends forwardly downwardly from the rear wall 28 of the open portion 20 to the front wall 26 of the open portion 20 so as to make the rear wall 28 of the open portion 20 have a height that is greater than that of the front wall 26 of the open portion 20.

D. Specific Configuration of the Closed Portion 22.

The closed portion 22 is generally rectangular-shaped in plan view.

The closed portion 22 comprises a front wall 36, a pair of side walls 38, and a floor 40.

The front wall 36 of the closed portion 22, the pair of side walls 38 of the closed portion 22, and the floor 40 of the closed portion 22 are for being free of the pail rest 14 of the open A-frame ladder 12 and the head step 16 of the open A-frame ladder 12 when the tray 10 is in use.

The pair of side walls 38 of the closed portion 22 extend forwardly from, and are one-piece with, the pair of side walls 30 of the open portion 20, respectively.

The front wall 26 of the open portion 20 becomes a partition 42.

The partition 42 of the front wall 26 of the open portion 20 divides the tray 10 into the open portion 20 and the closed portion 22.

The front wall 36 of the closed portion 22 and the pair of side walls 38 of the closed portion 22 extend upwardly from the floor 40 of the closed portion 22.

The front wall 36 of the closed portion 22 and the pair of side walls 38 of the closed portion 22, together with the front wall 26 of the open portion 20, form a fence 44. The fence 44 of the closed portion 22 is for preventing an item 46 resting on the floor 40 of the closed portion 22 from inadvertently falling off the closed portion 22.

The pair of side walls 38 of the closed portion 22 are identical to each other.

Each side wall 38 of the closed portion 22 has a lower edge 48 and an upper edge 50.

The lower edge 48 of each side wall 38 of the closed portion 22 is straight.

The lower edge 48 of each side wall 38 of the closed portion 22 extends forwardly upwardly from the front wall 26 of the open portion 20 to the front wall 36 of the closed portion 22.

The upper edge 50 of each side wall 38 of the closed portion 22 is straight.

The upper edge 50 of each side wall 38 of the closed portion 22 extends forwardly upwardly from the front wall 26 of the open portion 22 to the front wall 36 of the closed portion 22 so as to make the front wall 26 of the open portion 20 have a height that is greater than that of the front wall 36 of the closed portion 22.

The lower edge 48 of each side wall 38 of the closed portion 22 extends forwardly upwardly at an angle that is greater than that of the upper edge 50 of each side wall 38 of the closed portion 22.

E. Impressions.

It will be understood that each of the elements described above or two or more together may also find a useful application in other types of constructions differing from the types described above.

While the embodiments of the present invention have been illustrated and described as embodied in a tray for removably receiving an open A-frame ladder having a pail rest, a head step, and side rails, for being rigid and non-pivotable, for being free of the pail rest of the open A-frame ladder, for being free of the head step of the open A-frame ladder, and for not requiring holes in the side rails of the open A-frame ladder, however, they are not limited to the details shown, since it will be understood that various omissions, modifications, substitutions, and changes in the forms and details of the embodiments of the present invention illustrated and their operation can be made by those skilled in the art without departing in any way from the spirit of the embodiments of the present invention.

Without further analysis, the foregoing will so fully reveal the gist of the embodiments of the present invention that others can by applying current knowledge readily adapt them for various applications without omitting features that from the standpoint of prior art fairly constitute characteristics of the generic or specific aspects of the embodiments of the present invention.

1. A tray for removably receiving an open A-frame ladder having a pail rest, a head step, side rails, and a pair of spreaders, for being rigid and non-pivotable, for being free of the pail rest of the open A-frame ladder, for being free of the head step of the open A-frame ladder, and for not requiring holes in the side rails of the open A-frame ladder to attach to, said tray comprising:
a) an open portion; and
b) a closed portion;
wherein said open portion extends rigidly from said closed portion;
wherein said open portion is for removably receiving the open A-frame ladder and rests between the pail rest of the open A-frame ladder and the head step of the open A-frame ladder when said tray is in use so as to allow said open portion and said closed portion to be free of the pail rest of the open A-frame ladder and the head step of the open A-frame ladder when said tray is in use;
wherein said open portion is for non-pivotally receiving the open A-frame ladder when said tray is in use;
wherein said open portion is for not requiring holes in the side rails of the open A-frame ladder to attach to when said tray is in use;
wherein said open portion is defined by a pair of side walls;
wherein said closed portion comprises a pair of side walls; and
wherein said pair of side walls defining said open portion are collinear with said pair of side walls of said closed portion, respectively.

2. The tray of claim 1, wherein said open portion is generally rectangular-shaped in plan view.

3. The tray of claim 1, wherein said open portion has an open center; and
wherein said open center of said open portion is for removably and non-pivotally receiving the open A-frame ladder when said tray is in use.

4. The tray of claim 3, wherein said open center of said open portion is defined by a front wall.

5. The tray of claim 4, wherein said open center of said open portion is defined by a rear wall.

6. The tray of claim 5,
wherein said pair of side walls of said open portion are for acting like an additional pair of spreaders for the open A-frame ladder in addition to the pair of spreaders of the open a-frame ladder; and
wherein said front wall of said open portion, said rear wall of said open portion, and said pair of side walls of said open portion are for being free of the pail rest of the open A-frame ladder and the head step of the open A-frame ladder when said tray is in use.

7. The tray of claim 4, wherein said front wall of said open portion slants rearwardly for matching slant of, so as to rest snugly against, a front pair of side rails of the open A-frame ladder.

8. The tray of claim 5, wherein said rear wall of said open portion slants forwardly for matching slant of, so as to rest snugly against, a rear pair of side rails of the open A-frame ladder.

9. The tray of claim 1, wherein said pair of side walls of said open portion are identical to each other.

10. The tray of claim 1, wherein each side wall of said open portion has a lower edge; and
wherein said lower edge of each side wall of said open portion extends forwardly horizontally from said rear wall of said open portion to said front wall of said open portion.

11. The tray of claim 10, wherein said lower edge of each side wall of said open portion is straight.

12. The tray of claim 1, wherein each side wall of said open portion has an upper edge; and
wherein said upper edge of each side wall of said open portion extends forwardly downwardly from said rear wall of said open portion to said front wall of said open portion.

13. The tray of claim 12, wherein said upper edge of each side wall of said open portion is straight.

14. The tray of claim 5, wherein said rear wall of said open portion has a height that is greater than that of said front wall of said open portion.

15. The tray of claim 1, wherein said pair of side walls of said open portion are vertically oriented for matching vertical of, so as to rest snugly against, each side pair of side rails of the open A-frame ladder.

16. The tray of claim 1, wherein said closed portion is generally rectangular-shaped in plan view.

17. The tray of claim 4, wherein said closed portion comprises a front wall; and
wherein said front wall of said closed portion is for being free of the pail rest of the open A-frame ladder and the head step of the open A-frame ladder when said tray is in use.

18. The tray of claim 17,
wherein said pair of side walls of said closed portion are for being free of the pail rest of the open A-frame ladder and the head step of the open A-frame ladder when said tray is in use.

19. The tray of claim 1, wherein said closed portion comprises a floor; and
wherein said floor of said closed portion is for being free of the pail rest of the open A-frame ladder and the head step of the open A-frame ladder when said tray is in use.

20. The tray of claim 1, wherein said pair of side walls of said closed portion extend forwardly from said pair of side walls of said open portion, respectively.

21. The tray of claim 1, wherein said pair of side walls of said closed portion are one-piece with said pair of side walls of said open portion, respectively.

22. The tray of claim 4, wherein said front wall of said open portion becomes a partition by dividing said tray into said open portion and said closed portion.

23. The tray of claim 19, wherein said front wall of said closed portion and said pair of side walls of said closed portion extend upwardly from said floor of said closed portion.

24. The tray of claim 19, wherein said front wall of said closed portion and said pair of side walls of said closed portion, together with said front wall of said open portion, form a fence; and
wherein said fence of said closed portion is for preventing an item resting on said floor of said closed portion from inadvertently falling off said closed portion.

25. The tray of claim 1, wherein said pair of side walls of said closed portion are identical to each other.

26. The tray of claim 1, wherein each side wall of said closed portion has a lower edge; and
wherein said lower edge of each side wall of said closed portion extends forwardly upwardly from said front wall of said open portion to said front wall of said closed portion.

27. The tray of claim 26, wherein each side wall of said closed portion has an upper edge; and
wherein said upper edge of each side wall of said closed portion extends forwardly upwardly from said front wall of said open portion to said front wall of said closed portion.

28. The tray of claim 17, wherein said front wall of said open portion has a height that is greater than that of said front wall of said closed portion.

29. The tray of claim 26, wherein said lower edge of each side wall of said closed portion is straight.

30. The tray of claim 27, wherein said upper edge of each side wall of said closed portion is straight.

31. The tray of claim 27, wherein said lower edge of each side wall of said closed portion extends forwardly upwardly at an angle that is greater than that of said upper edge of each side wall of said closed portion.
